(19) United States
(12) Patent Application Publication
(10) Pub. No.: US 2010/0050841 A1
(43) Pub. Date: Mar. 4, 2010

(54) MEAT CUTTING APPARATUS

(76) Inventor: Yan Hoi Yeung, Bayside, NY (US)

Correspondence Address: Shuang Zhang, Suite 501, 136-40 39th Ave, Flushing, NY, 11354, US

(21) Appl. No.: 12/201,667

(22) Filed: Aug. 29, 2008

(51) Int. Cl. B26D 7/00

(52) U.S. Cl. 83/411.1

(57) ABSTRACT

Disclosed is a meat cutting apparatus. The apparatus comprises a continually-cutting blade and a periodically-cutting blade. The cutting directions of the two blades are substantially orthogonal. And the two blades are driven by the same force generating source.

### FIELD OF INVENTION

This invention relates to apparatus cutting meat objects into pieces.

### BACKGROUND OF THE INVENTION

Devices suitable for chopping and shredding vegetables, such as heads of lettuce, are described in U.S. Pat. Nos. 3,924,501, 4,346,634, and etc. In these patents, the food object was placed on a set of blades and a pusher head pushed the object directly against and through the blades. As a result, the food object was cut into shapes predefined by the blades. However, they are generally not suitable for cutting meat objects, such as Chinese barbecued pork or frozen steak.

In view of the foregoing, it is apparent that there exists a need in the art for chopping apparatus which overcomes, mitigates, or solves the above problems in the art. More particularly, it is apparent that there exists a need for chopping apparatus which is capable of cutting meat objects easily.

The present invention alleviates the drawbacks associated with the prior arts. The objective of the invention is to create an apparatus that can easily cut meat objects into pieces.

It is also an objective of the present invention that different blade sets are interchangeably assembled on the apparatus in order to cut the meat object into different sizes.

### SUMMARY OF THE INVENTION

To solve the problems associate with the prior arts, this invention disclosed a meat chopping apparatus, comprising:

a force generator that drives simultaneously at least one first blade and at least one second blade;

said first blade that continuously cuts the meat object into strips in a first direction; and

said second blade that periodically cuts the meat object into pieces in a second direction substantially orthogonal to the first direction.

To be more specific, this invention disclosed a meat chopping apparatus, comprising: a rotating shaft that is directly affixed to the center of wheel blades and connects through an eccentric shaft to vertical blades, whereby rotating said rotating shaft rotates the wheel blades to continuously cut the meat object into strips in the first direction and also causes the vertical blades to periodically cut the meat object into pieces in the second direction substantially orthogonal to the first direction. The rotating shaft is driven either manually or by a motor.

Any other objectives, advantages, features and applicabilities of the present invention re elucidated in the following description of an illustrative embodiment of the invention in relation to the drawing. All described and/or graphically shown features whether per se or in arbitrary combination are an object the present invention, regardless of their summarization in the claims or their mutual relationships.

### BRIEF LIST OF REFERENCE NUMERALS UTILIZED IN THE DRAWING

10—A preferred embodiment of this present invention (10)
11—Rotating Shaft (11)
12—Feeder (12)
13—Vertical Blades (13)
14—Wheel Blades (14)
15—Base Assembly (15)
16—Sliding Track (16)
21—Eccentric Shaft (21)
22—Connecting Shafts (22)
23—Pressing Joint (23)
24—Pressing Shaft (24)
25—Reset Spring (25)

### BRIEF DESCRIPTION OF THE DRAWINGS

A more thorough understanding of the present invention may be obtained by a study of the following detailed description taken in connection with the accompanying drawings in which:

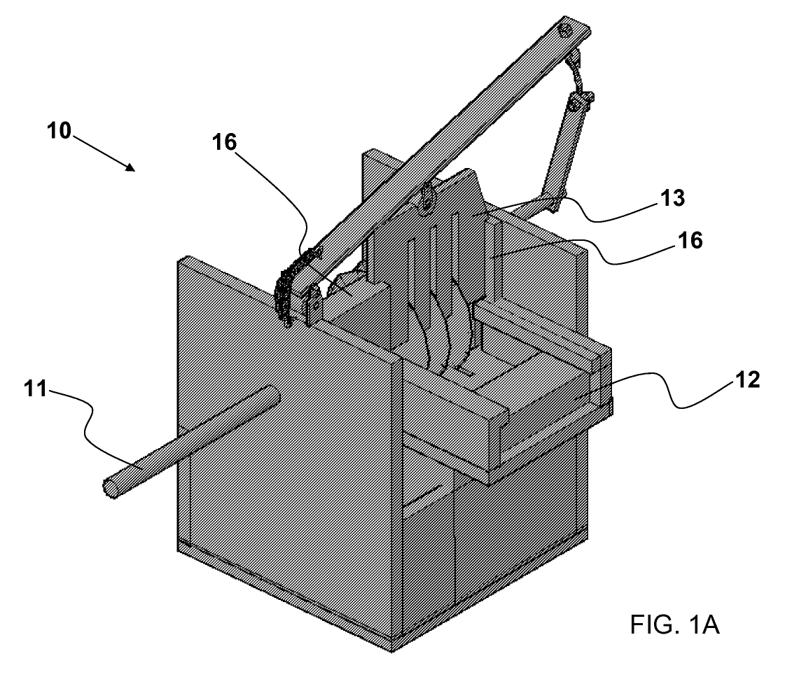

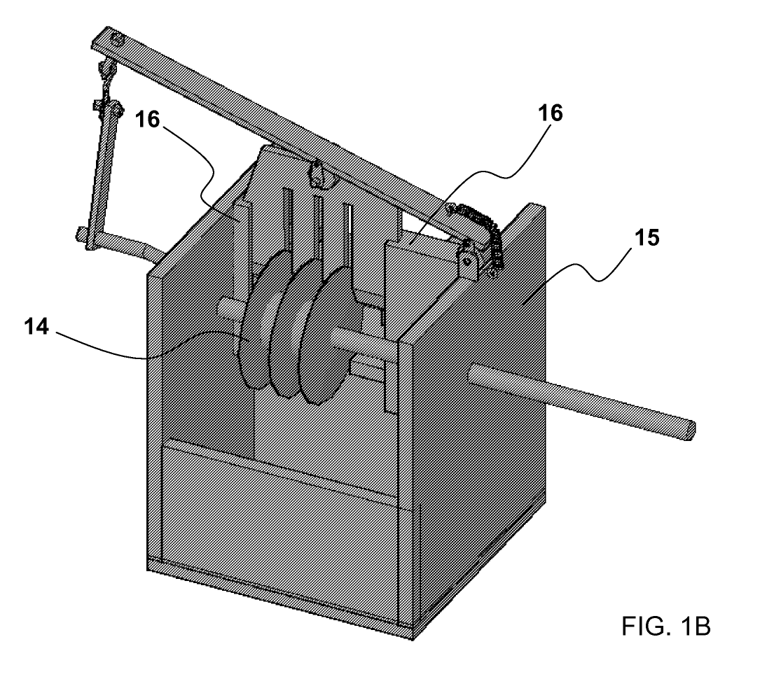

FIG. 1A is a front perspective view of a preferred embodiment of the present invention.

FIG. 1B is a back perspective view of the embodiment of FIG. 1A.

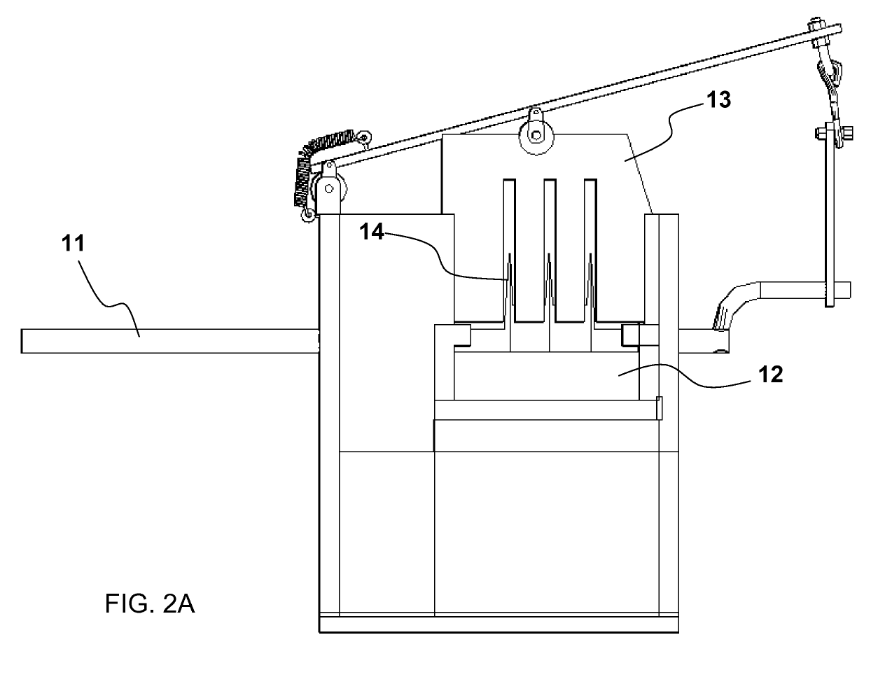

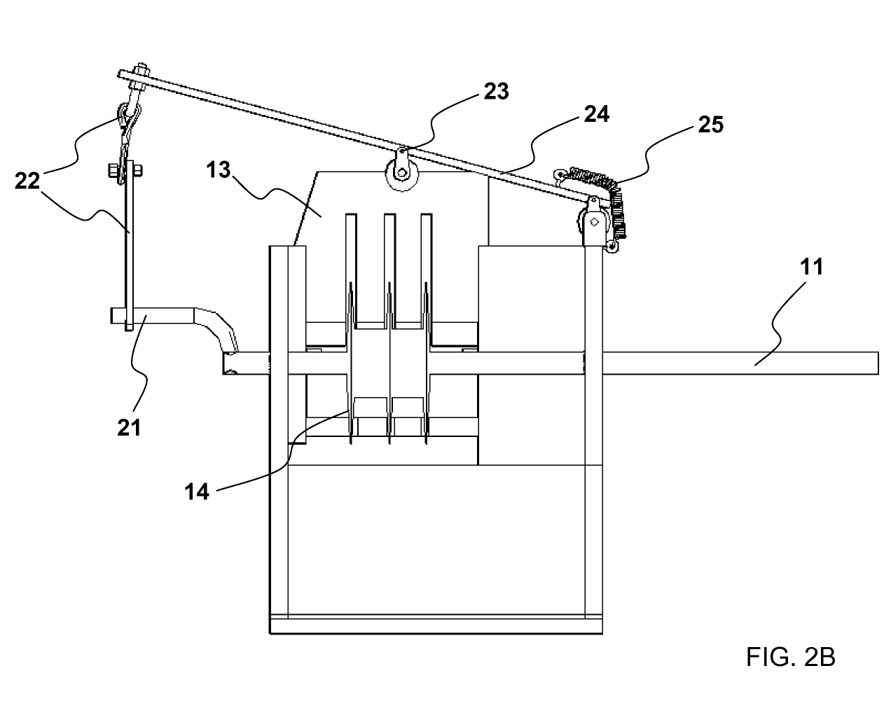

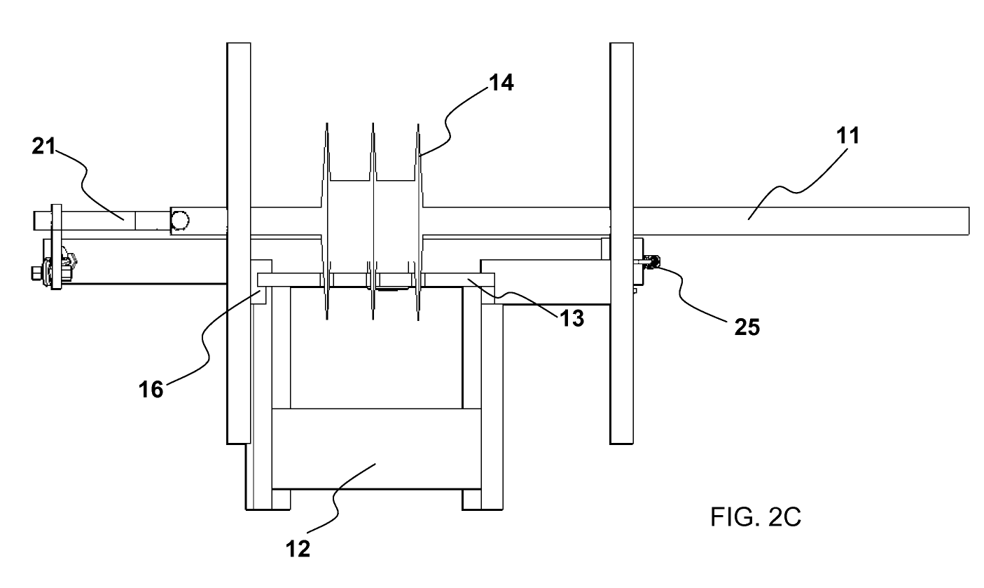

FIG. 2A is a front view of the embodiment of FIG. 1A.

FIG. 2B is a back view of the embodiment of FIG. 1A.

FIG. 2C is a top view of the embodiment of FIG. 1A, where the pressing shaft 24 is removed.

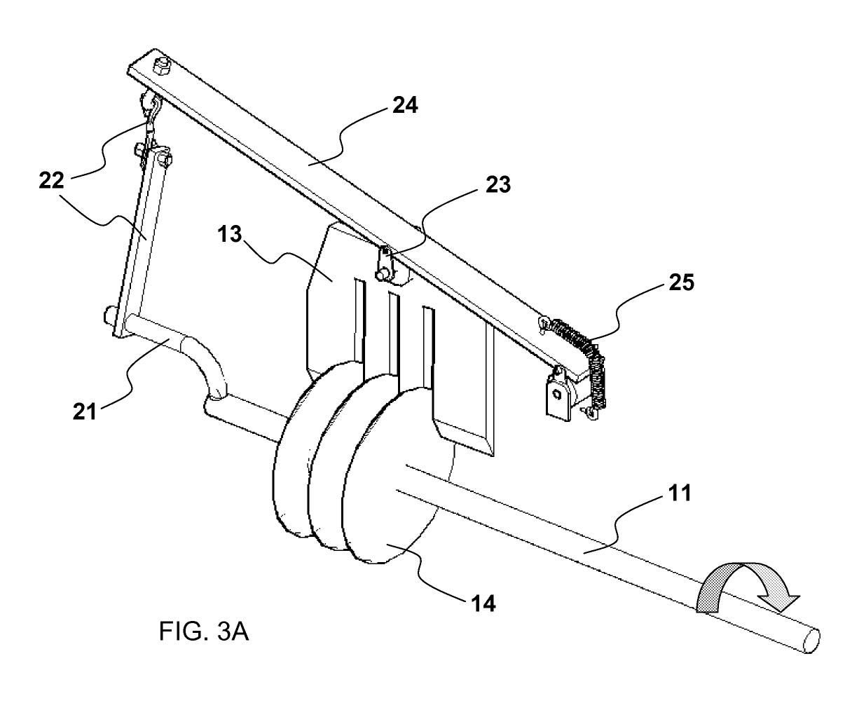

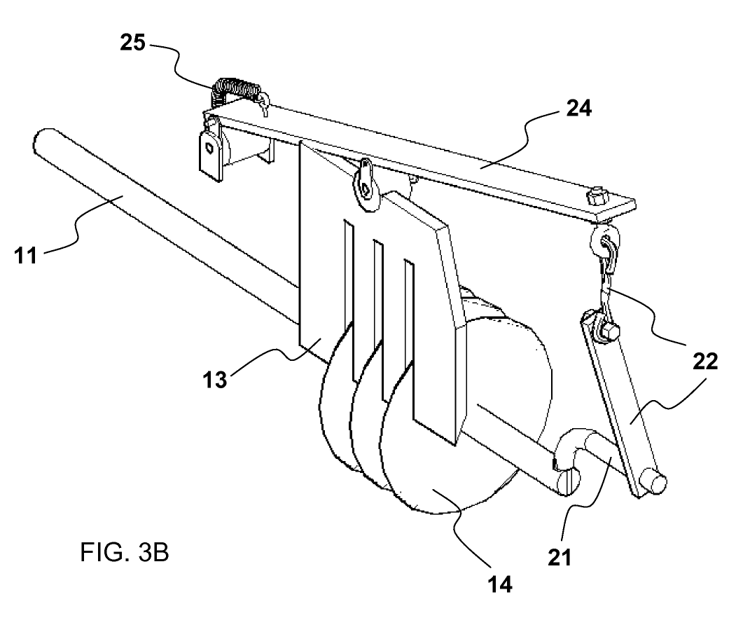

FIG. 3A is a front perspective view of blades and mechanical connections of the embodiment of FIG. 1A.

FIG. 3B is a back perspective view of blades and mechanical connections of the embodiment of FIG. 1A.

### DESCRIPTION OF THE PREFERRED EMBODIMENTS

Referring now to FIG. 1A and FIG. 1B, the present invention is shown in a preferred embodiment. The meat cutting apparatus 10 comprises a force generating and transferring system, wheel blades 14, vertical blades 13, a feeder 12, and a base assembly 15 that supports the force generating and transferring system, the blades and the feeder altogether. The force generating and transferring system comprises a rotating shaft 11, a set of connecting shafts and pressing shafts, and a reset spring. The force generating and transferring system is securely affixed to the base assembly 15. The feeder 12 pushes a meat object against the wheel blades 14. By operating the rotating shaft 11, the wheel blades 14 cut the meat object into strips in a continuous fashion, and then the vertical blades 13 cut the strips periodically into pieces. Both blades are removable to facilitate cleaning and are exchangeable so that different blade sets can be installed to generate different sizes of meat pieces.

Referring to FIG. 2A, FIG. 2B and FIG. 2C, they are the front view, the back view and the top view of the meat cutting apparatus 10 in FIG. 1A respectively, showing relative positions of the wheel blades 14, the vertical blades 13 and the feeder 12. In the preferred embodiment, a portion of the wheel blades 14 fit right within the gaps between the vertical blades 13. Despite the setting in the preferred embodiment, other arrangements between the wheel blades and the vertical blades are possible. In the preferred embodiment, the vertical blades 13 moves up and down along the sliding track 16 as the rotating shaft 11 turns.

The details of the connections between the rotating shaft 11 and the vertical blades 13 are shown in FIG. 2B, FIGS. 3A and 3B. At the end of the rotating shaft 11, there is an eccentric shaft 21 and connecting shafts 22, through which the pressing shaft 24 travels up and down as the rotating shaft 11 turns. The movement of the pressing shaft 24 connects to the vertical blades 13 by a pressing joint 23 and forces the vertical blades 13 to cut a meat object periodically. A reset spring 25 assists pulling up the vertical blades 13 during the rotation of the rotating shaft 11.

In the preferred embodiment, the meat cutting apparatus can be operated manually or by a motor.

It is worth noting that the vertical blades 13 might also be constructed as thin blades attached to a vertical supporting board.

Therefore, we declare that although an exemplary embodiment of the invention has been disclosed herein for purposes of illustration, it should be understood that various changes, modifications and substitutions might be incorporated in such embodiment without departing from the spirit of the invention as defined by the claims which follow.

What is claimed is:

1. An apparatus cutting a meat object into pieces, comprising:
a first cutting means continuously cutting the meat object into strips in a first direction;
a second cutting means periodically cutting the meat object into pieces in a second direction substantially orthogonal to the first direction; and
a force generating means driving both said cutting means simultaneously.

2. An apparatus cutting a meat object into pieces, comprising:
a force generator that drives simultaneously at least one first blade and at least one second blade;
said first blade that continuously cuts the meat object into strips in a first direction; and
said second blade that periodically cuts the meat object into pieces in a second direction substantially orthogonal to the first direction.

3. A meat cutting apparatus in the claim 2, said force generator comprises a rotating shaft that is directly attached to said first blade and connects through a linker to said second blade.

4. A meat cutting apparatus in the claim 2, said first blade is wheel blade and said rotating shaft is affixed to the center of said first blade, whereby rotating said shaft rotates said first blade to continuously cut the meat object into strips in the first direction.

5. A meat cutting apparatus in the claim 2, said linker connects to said second blade in a way said second blade periodically cuts the meat object into pieces in the second direction substantially orthogonal to the first direction.
